(19) United States
(12) Patent Application Publication
(10) Pub. No.: US 2016/0132934 A1
(43) Pub. Date: May 12, 2016

(54) Effective Mobile Marketing

(71) Applicant: Kahuna, Inc., Palo Alto, CA (US)

(72) Inventors: Jon Hartlaub, Mountain View, CA (US); Jacob Taylor, Los Altos, CA (US); James Sprinkle, Antioch, CA (US); Adam Marchick, Menlo Park, CA (US); Jason Zoss, Belmont, CA (US)

(21) Appl. No.: 14/939,867

(22) Filed: Nov. 12, 2015

Related U.S. Application Data
(60) Provisional application No. 62/242,118, filed on Oct. 15, 2015.
(60) Provisional application No. 62/078,954, filed on Nov. 12, 2014.

(51) Int. Cl. G06Q 30/02; H04L 29/08

(52) U.S. Cl. CPC G06Q 30/0267; H04L 67/306; H04L 67/22; G06Q 30/0269

(57) ABSTRACT

Various embodiments of the present technology provide for systems and methods to automatically measure and tune campaigns to achieve the most effective campaigns (e.g., balancing the most desired outcomes against the least negative outcomes and opportunity cost of sending) without requiring intervention by the campaign sender. By using various embodiments of campaign message selection and/or send time selection optimization, the sender does not have to manage and manually tune a multitude of experiments. Some embodiments of the technology leverage real-time user profiles to help send relevant messages to the right person at the right time on the right device. This helps customers of the marketing system delight their users with relevant messages, while boosting their bottom line and the brand experience.

### CROSS-REFERENCE TO RELATED APPLICATION(S)

The present application claims priority to and benefit from U.S. Provisional Patent Application No. 62/242,118 titled “Effective Mobile Marketing” filed on Oct. 15, 2015, and U.S. Provisional Patent Application No. 62/078,954 titled “Effective Mobile Marketing” filed on Nov. 12, 2014, the entire content of each of which is herein expressly incorporated by reference.

### TECHNICAL FIELD

Various embodiments of the present technology generally relate to systems and methods for mobile marketing. More specifically, some embodiments relate to systems and methods to automatically measure and tune mobile device marketing campaigns to achieve the most effective campaigns without requiring intervention by the campaign sender.

### BACKGROUND

Mobile electronic devices (such as mobile phones, computer tablets, wearable devices, and the like) have become ubiquitous in modern life. In addition to increasingly advanced computing capabilities (e.g., with multi-core processors, increased memory, etc.), the mobile devices are becoming smaller and lighter. These devices also offer a variety of other features and options such as, but not limited to, cameras, voice recognition, touch screens, Wi-Fi, SMS and MMS messaging, web browsers, voice/video calling, and GPS capabilities that improve the end-user's experience with the device. Software applications installed by the manufacturer or end-user further enhance the capabilities of the device. As a result, mobile devices now permeate the market with many end-users having multiple devices.

Traditionally, in order to target these end-users, marketing campaigns have required the campaign sender to design and set a variety of fixed variables. For example, traditional systems may have a campaign sender determine the content of the message and how long to wait to send the message. In some cases, these traditional systems may require the campaign sender to explicitly divide traffic between different messages (e.g., send 25% to message A, 33% to message B, 42% to message C). The number of variables that a sender needs to manage and tune in these traditional systems can be burdensome and result in inefficient marketing campaigns. As such, there are a number of challenges and inefficiencies created in traditional marketing systems. It is with respect to these and other problems that embodiments of the present technology have been made.

### SUMMARY

Various embodiments of the present technology generally relate to systems and methods for mobile marketing. More specifically, some embodiments relate to systems and methods to automatically measure and tune mobile device marketing campaigns to achieve the most effective campaigns without requiring intervention by the campaign sender.

Some embodiments provide for computer-implemented method for operating a mobile marketing platform that includes receiving, at a mobile marketing platform via a communications network from one or more mobile devices, indications of user activity with the one or more mobile devices and event activity. Customized user profiles can be created from the indications of user activity with the one or more mobile devices and the event activity. In some embodiments, the customized user profiles include time profiles of usage of the one or more mobile devices. A request can be received, at the mobile marketing platform, to initiate a marketing campaign and may include an initial timeframe and frequency of the marketing campaign. In response, the marketing campaign can be automatically launched and the mobile marketing platform may access the customized user profiles and individually select a message to send, a send time for the message, and a target device for each user in a subset of users based on the customized user profiles. Once a message is sent to a user, the customized user profiles may be updated to indicate when and/or which message was sent.

Embodiments of the present invention also include computer-readable storage media containing sets of instructions to cause one or more processors to perform the methods, variations of the methods, and other operations described herein.

Some embodiments of a marketing platform include a memory, processor, communications module, event aggregation module, a campaign engine, a distribution engine, an evaluation engine, and/or a device tracking engine. Other embodiments may include additional or fewer components. The communications module can be configured to receive event data regarding usage of one or more mobile devices. The event aggregation module may be configured to aggregate the event data received via the communications module and generate one or more user profiles based on the event data. The campaign engine can launch a campaign that automatically tunes the content and send time based on the one or more user profiles. In addition, the campaign engine may evaluate each of the one or more user profiles and determine an optimal send delay for each user based on the one or more user profiles and determine if a message should be sent to each of the one or more users. The campaign engine may also pass each message to a distribution engine (e.g., third-party push service, third party email server, etc.) that should be sent to each of the one or more users. The distribution engine transmits the message upon passage of the optimal send delay for each user. The device tracking engine can be used to track the usage of the one or more mobile devices.

While multiple embodiments are disclosed, still other embodiments of the present technology will become apparent to those skilled in the art from the following detailed description, which shows and describes illustrative embodiments of the technology. As will be realized, the technology is capable of modifications in various aspects, all without departing from the scope of the present technology. Accordingly, the drawings and detailed description are to be regarded as illustrative in nature and not restrictive.

### BRIEF DESCRIPTION OF THE DRAWINGS

Embodiments of the present technology will be described and explained through the use of the accompanying drawings.

FIG. 1 illustrates an example of a communications environment in which some embodiments of the present technology may be utilized.

FIG. 2 is an example of a cloud-based interface architecture that may be used in one or more embodiments of the present technology.

FIG. 3 is an example of a cloud-based processing architecture that may be used in various embodiments of the present technology.

FIG. 4 is a flowchart illustrating an example of a set of operations that can be used in a sample campaign with filtering and optimal time delivery.

FIG. 5 is a flowchart illustrating an example of a set of operations that can be used in a sample campaign where a company wants to reach out to their users after a time delay.

FIG. 6 is a flowchart illustrating an example of a set of operations that can be used in a message optimized campaign.

FIGS. 7A-7D illustrate several examples of histograms of the collected and processed customer behavior according to various embodiments of the present technology.

FIGS. 8A-8B illustrate plots of unconditioned profile data and conditioned profile data that may be used in one or more embodiments of the present technology.

FIG. 9 is a block diagram illustrating an example of a processing flow for computing an optimal send time.

FIG. 10 is a block diagram illustrating an example machine representing the computer systemization of the marketing system.

### DETAILED DESCRIPTION

Marketing campaigns can have a huge effect on users. Each marketing campaign has a chance to delight a user, encourage a user to take a preferred action, educate a user, provide a special offer, or potentially frustrate or upset a user. Some percentage of users will receive the campaign and terminate their relationship (e.g., uninstall the application, opt-out of messaging, etc.). Small changes in the timing of a message or the contents of the message can have a dramatic effect on the response rate of the message. Traditional systems typically have a campaign sender determine the content of the message and how long to wait to send the message. In addition, these traditional systems need the campaign sender to explicitly divide traffic between different messages (e.g., send 25% to message A, 33% to message B, 42% to message C). The large number of variables in content, timing and other factors that need to be managed and set by a campaign sender may not result in the most successful marketing campaign.

In contrast, various embodiments of the present technology provide for systems and methods to automatically measure and tune campaigns to achieve the most effective campaigns (e.g., balancing the most desired outcomes against the least negative outcomes and opportunity cost of sending) without requiring intervention by the campaign sender. By using various embodiments of campaign message selection and/or send time selection optimization, the sender does not have to manage and manually tune a multitude of experiments. In addition, some embodiments can respond more quickly and reliably than a human attempting to monitor and update the campaign to maximize the response.

Various embodiments of the present technology include a mobile engagement engine. The mobile engagement engine can create user profiles for each group of people based on stream based analytics keeping track of a user's attributes and usage history. Some embodiments can use these user profiles to send relevant personalized marketing messages via many channels. For example, campaigns of personalized marketing messages may be sent by push notifications, in-app messages, SMS messages, application inbox notifications, web push notifications, email, or any other channel or delivery mechanism. The groups of people could be a single individual, a business entity, or other groupings.

Some embodiments of the technology leverage the real-time user profiles to help send relevant messages to the right person at the right time on the right device. This helps customers of the marketing system delight their users with relevant messages while boosting their bottom line and the brand experience. Further, some embodiments ensure that push notifications are only triggered and sent to users who would not otherwise convert. The system can monitor user behavior in real-time and understand the time interval in which a percentage (e.g., 98%) of users will convert without intervention. This ensures that the only users who would not convert organically receive a notification, so that a campaign organizer does not annoy users with unnecessary push notifications.

In the following description, for the purposes of explanation, numerous specific details are set forth in order to provide a thorough understanding of embodiments of the present technology. It will be apparent, however, to one skilled in the art that embodiments of the present technology may be practiced without some of these specific details.

Moreover, the techniques introduced here can be embodied as special-purpose hardware (e.g., circuitry), as programmable circuitry appropriately programmed with software and/or firmware, or as a combination of special-purpose and programmable circuitry. Hence, embodiments may include a machine-readable medium having stored thereon instructions that may be used to program a computer (or other electronic devices) to perform a process. The machine-readable medium may include, but is not limited to, floppy diskettes, optical discs, compact disc read-only memories (CD-ROMs), magneto-optical disks, ROMs, random access memories (RAMs), erasable programmable read-only memories (EPROMs), electrically erasable programmable read-only memories (EEPROMs), application-specific integrated circuits (ASICs), magnetic or optical cards, flash memory, or other type of media/machine-readable medium suitable for storing electronic instructions.

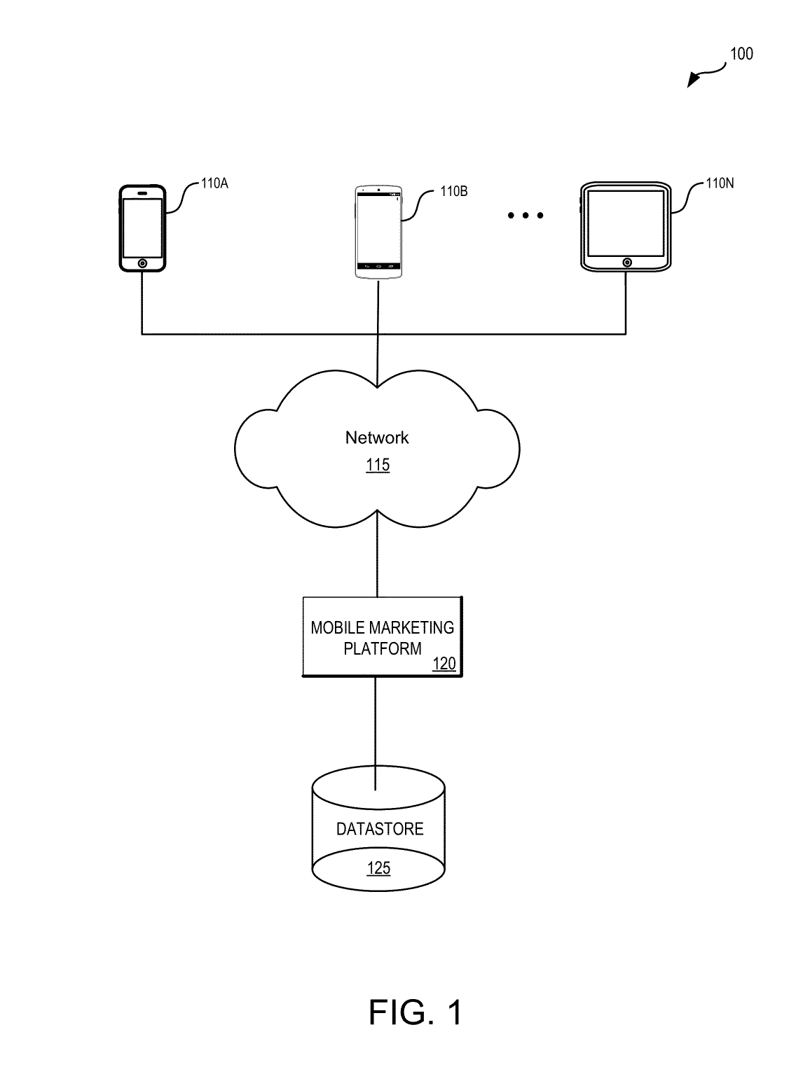

FIG. 1 illustrates an example of a communications environment 100 in which some embodiments of the present technology may be utilized. As illustrated in FIG. 1, communications environment 100 may include one or more mobile devices 110A-110N (such as a mobile phone, tablet computer, mobile media device, mobile gaming device, vehicle-based computer, wearable computing device, etc.), communications network 115, mobile marketing platform 120, and datastore 125. Mobile devices 110A-110N can include network communication components that enable the mobile devices to communicate with mobile marketing platform 120, remote servers or other portable electronic devices by transmitting and receiving wireless signals using licensed, semi-licensed or unlicensed spectrum over communications network 115.

In some cases, communication network 115 may be comprised of multiple networks, even multiple heterogeneous networks, such as one or more border networks, voice networks, broadband networks, service provider networks, Internet Service Provider (ISP) networks, and/or Public Switched Telephone Networks (PSTNs), interconnected via gateways operable to facilitate communications between and among the various networks. Communications network 115 can also include third-party communications networks such as a Global System for Mobile (GSM) mobile communications network, a code/time division multiple access (CDMA/TDMA) mobile communications network, a 3rd or 4th generation (3G/4G) mobile communications network (e.g., General Packet Radio Service (GPRS/EGPRS)), Enhanced Data rates for GSM Evolution (EDGE), Universal Mobile Telecommunications System (UMTS), or Long Term Evolution (LTE) network, or other communications network.

Those skilled in the art will appreciate that various other components (not shown) may be included in mobile device 110A-110N to enable network communication. For example, mobile devices 110A-110N may be configured to communicate over a GSM mobile telecommunications network. As a result, mobile devices 110A-110N may include a Subscriber Identity Module (SIM) card that stores an International Mobile Subscriber Identity (IMSI) number that is used to identify the mobile device on the GSM mobile communications network or other networks, for example, those employing 3G and/or 4G wireless protocols. If mobile devices 110A-110N are configured to communicate over another communications network, mobile devices 110A-110N may include other components that enable it to be identified on the other communications networks.

In some embodiments, mobile devices 110A-110N may include components that enable them to connect to a communications network using Generic Access Network (GAN) or Unlicensed Mobile Access (UMA) standards and protocols. For example, mobile devices 110A-110N may include components that support Internet Protocol (IP)-based communication over a Wireless Local Area Network (WLAN) and components that enable communication with the telecommunications network over the IP-based WLAN. Mobile devices 110A-110N may include one or more mobile applications that need to transfer data or check-in with mobile marketing platform 120. Mobile marketing platform 120 may use real-time user profiles to help send relevant messages to the right person at the right time on the right device.

In accordance with various embodiments, mobile marketing platform 120 may automatically measure and tune marketing campaigns to achieve the most effective campaigns by balancing the most desired outcomes against the least negative outcomes and opportunity cost of sending without requiring intervention by the campaign sender. By using various embodiments of campaign message selection and/or send time selection optimization, mobile marketing platform 120 removes the need for the sender to actively manage and manually tune a multitude of experiments. In some embodiments, mobile marketing platform 120 can include various components such as a mobile engagement engine to create user profiles for groups of people (e.g., single individuals, business entities, or other groupings) based on stream based analytics keeping track of a user's attributes and usage history. Some embodiments of marketing platform 120 can use these user profiles to send relevant personalized marketing messages via many channels. For example, campaigns of personalized marketing messages may be sent by push notifications, in-app messages, SMS messages, application inbox notifications, web push notifications, email, or any other delivery mechanism. Various analytics, user profiles, campaign configurations, advertisements, and other information can be stored and accessed in datastore 125.

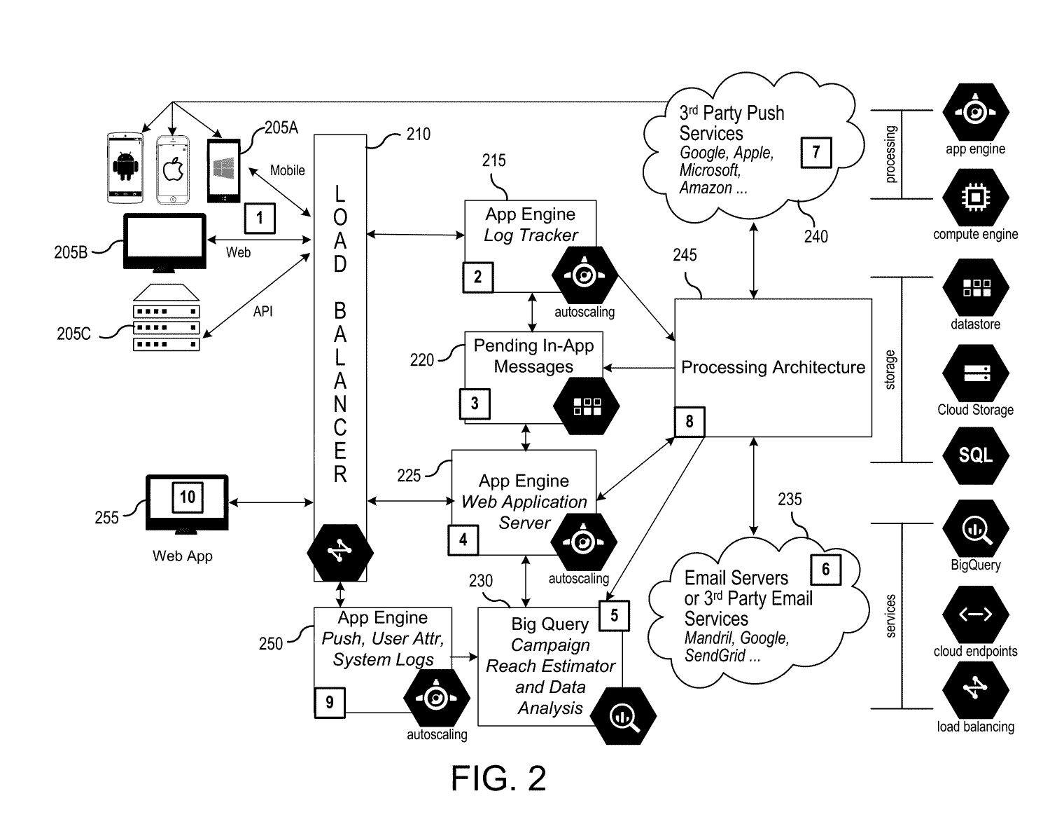

FIG. 2 is an example of a cloud-based interface architecture that may be used in one or more embodiments of the present technology. As illustrated in FIG. 2, notifications of various events from various mobile devices 205A, web 205B, or API's 205C are sent to load balancer 210. These events are passed to app engine 215 where the events are tracked for users along with pending in-app messages 220. The tracked events and pending in-app messages 220 are transmitted to a web application server 225 of the application engine which initiates data query 230. The data returned from data query 230 can be used by various components such as a campaign reach estimator, data analyzer or other module to design a customized campaign which can be executed by various email servers 235, push services 240 or other channels (not shown in FIG. 2) via the campaign processing architecture 245. App engine 250 can then log the push notifications sent, emails sent, user attributes, and/or other data regarding the campaign. This data and various analytics can be viewed via web application 255.

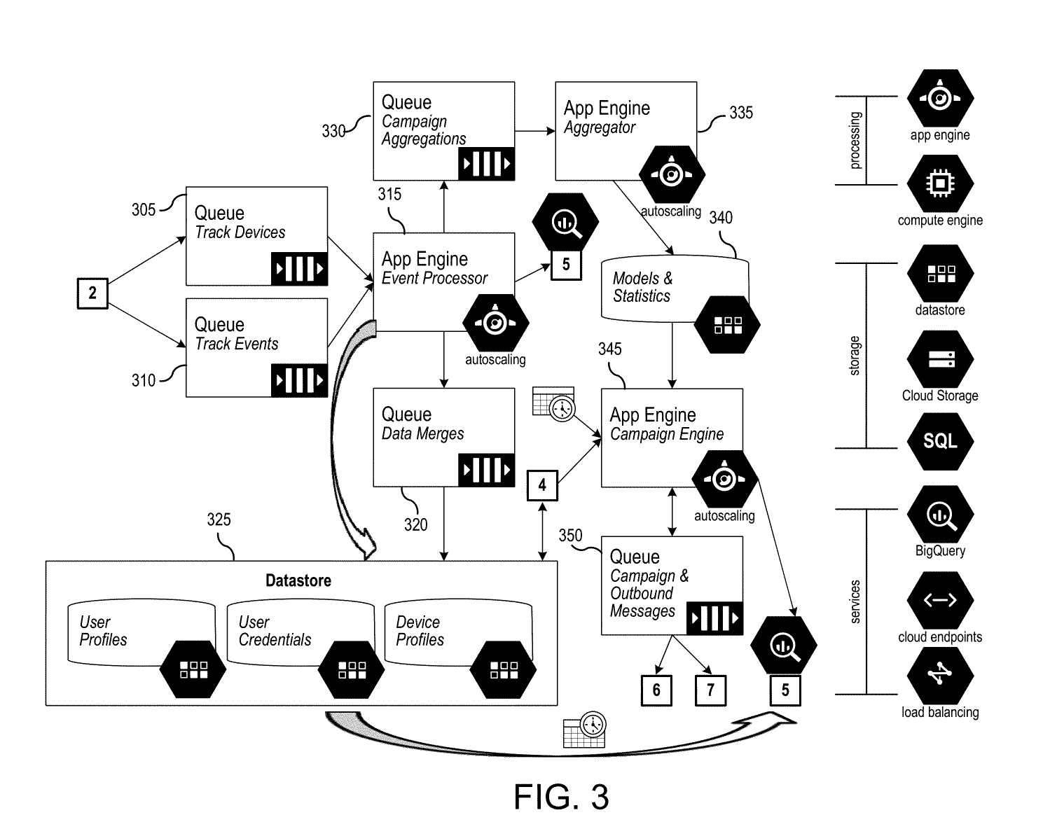

FIG. 3 is an example of a cloud-based processing architecture 245 that may be used in various embodiments of the present technology. As illustrated in FIG. 3, processing architecture 245 includes device tracking queue 305 to track device activity and event tracking queue 310 to track events. Application engine event processor 315 receives data regarding the device activity and various events associated with users and can merge the data in queue 320 until it can be stored in datastore 325. The data may be stored as part of user profiles, user credentials, and/or device profiles. In addition, application engine event processor 315 can queue the device and event data in aggregation queue 330 before sending it to aggregator 335 where the data is aggregated and used to generate various models and statistical profiles 340 of the aggregated user base. Campaign engine 345 can use these statistical models 340 to generate targeted campaigns, which can be queued in the outbound message queue before being transferred to various email servers 235, push services 240 or other channels (not shown in FIG. 2) for distribution.

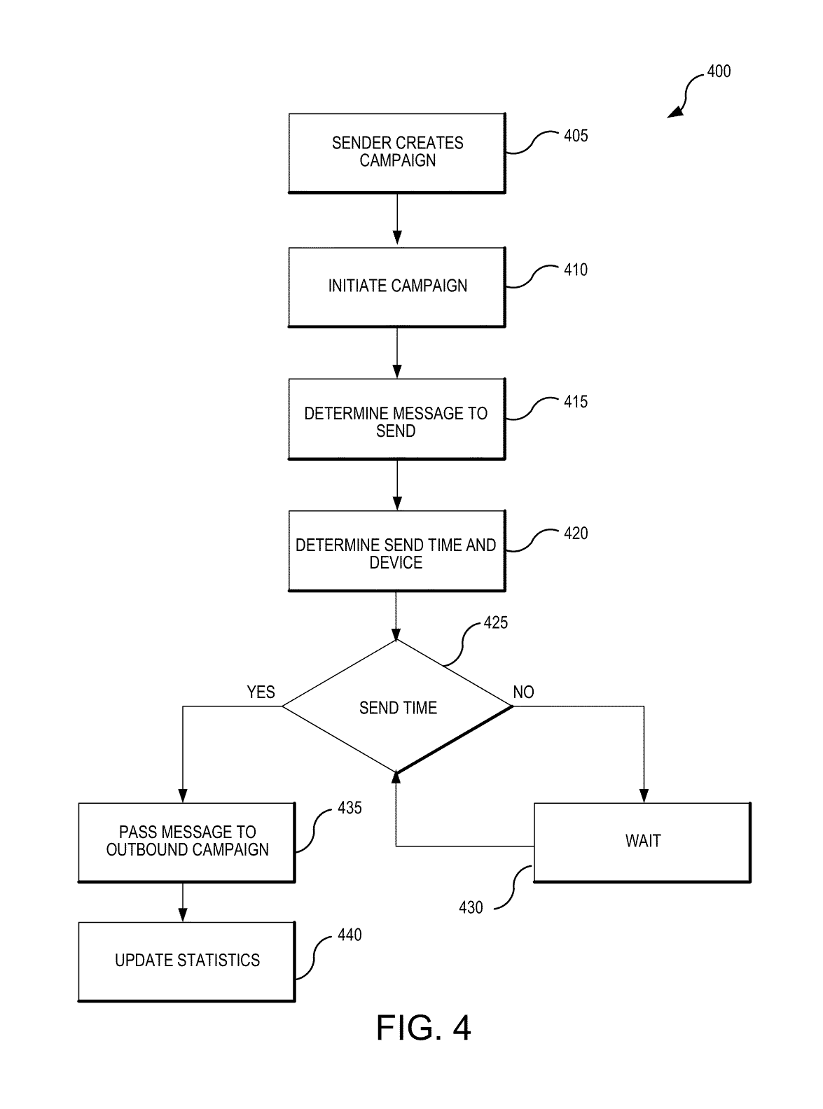

Various embodiments may use information about a user to determine which people should be included in a campaign. This information may include what actions the user has (or has not) previously taken, demographic information about the user, or other attributes of the user. FIG. 4 is a flowchart illustrating an example of a set of operations 400 that can be used in a sample campaign with filtering and optimal time delivery in accordance with some embodiments of the present technology. These operations allow for both person and device targeting.

As illustrated in FIG. 4, during creation operation 405 a sender creates a campaign. In accordance with various embodiments, the sender can name the campaign and specify when and how often the campaign will run (e.g., a one-time campaign as soon as possible). During creation operation 405 the sender can optionally define additional filters (e.g., purchases <5) which may be used to select which people should be included in the campaign. The sender may also set a send time to be optimal over a period of time (e.g., 4 hours from campaign start) and/or define one or more messages (e.g., two push messages). Once completed, the sender can initiate (or launch) the campaign during initiation operation 410.

When the campaign fires (e.g., immediately for ASAP campaign, as scheduled for scheduled one-time campaigns, on trigger for conversion campaigns, daily for lifecycle campaigns, etc.) a target user will be loaded and the system may check to see if any additional filters are met. If the filters are not met, then the campaign can stop sending messages to that user. In some embodiments, the system may determine if rate limiting is in effect. If a determination is made that rate limiting is in effect, then the system can determine if the user should be rate limited. If the user should be rate limited, then the system will stop sending messages to that user for a period of time. Rate limiting reasons may include verifying one or more of the following: 1) last time a message was sent to a user; 2) last time the user participated in this campaign; and/or 3) last time a message was sent to a device.

Based on this information about a user, the system can determine the message to send (e.g., by fixed percentage, by message optimization, etc.). The system may create a record or log of the send. The system may also update the user profile to record the fact that a method of communication was sent to the user. In some embodiments, the system may use a transitory store, such as memcached, to also store the fact that the user was sent a message to prevent storage eventual consistency from allowing a user to be double messaged.

During timing operation 420, the system may determine when to send the message. This may include a specific time or a window of time (e.g., delivered optimally to the user over the next 4 hours). Optimal time and device choice considerations may include one or more of the following: 1) checking the recent events the user has performed and which device the user was on (e.g., add to shopping cart-based campaigns may be sent to the same device); 2) if the device or channel is available for this user (e.g., has the user opted into push notifications); 3) how frequently a user is using each device during the window (e.g., the user chooses an iPhone while on the train going home but an iPad after arriving home); 4) how frequently a user completes the desired action on the particular device or device type (e.g., the user is three times more likely to complete a purchase on an iPad versus an iPhone); 5) based on recent events, has the user upgraded the device to a newer one (e.g., if the user switched from the iPhone 5 to an iPhone 6 but remains reachable on both, the system may choose to transfer the messaging to the iPhone 6); 6) how frequently a user completes the desired action at different periods during the time window (e.g., historically, has the user tended to purchase more frequently at 6 p.m. or 5 p.m.); and/or 7) how many activities the user has been performing over the past few days or weeks (e.g., is the user decreasing usage recently, keeping steady, or increasing usage). In some embodiments, the system may also use additional logic to spread out traffic to minimize impact on the sender's infrastructure or services.

Once a send time is set by timing operation 420, determination operation 425 determines whether the send time has been reached. If the send time has not been reached, then determination operation 425 branches to waiting operation 430. If determination operation 425 determines the send time has been reached, then determination operation 425 branches to passing operation 435 where the message is passed to an appropriate outbound campaign (e.g., queue the message for delivery via push notification, email, or in-app message). Recording operation 440 then updates the statistics used to determine the success rate for the message the user was sent (e.g., update send count for a particular message).

In some embodiments, the system may use information about the devices that a user owns to determine which device to send to and/or how to customize the message content (e.g., color, style, font, layout, graphics, etc.). This information may include the form factor of the device, the operating system on the device, the speed of the device, the version of the sender's application installed on the device, or the resolution of the device.

In some embodiments, the system may use past usage information to determine when to send a message to the user. This information could include device-specific or aggregate details about which events and how many events were performed during each day of the week, hour of the day, or day of the week and hour combination. Some embodiments may also use recent activities performed by the user (e.g., change the message if the user has added and removed the same item from their cart multiple times or possibly, change the message if the user has purchased more than once within a time period, such as the past week) to determine the best device to send to. This information may include the device on which the trigger event happened, which device was most recently used, or which device is most frequently used in the recent past.

### Campaigns

There are many situations where an action by one or more users will create a situation where a company will want to reach out to one or more users. One scenario might be if a user adds an item to a shopping cart and does not complete the checkout. Another scenario might be if a user shares an item with another user. In these situations, and many others, the company may want to reach out to one or more of the users involved.

### Time Optimization

In some embodiments, mobile marketing platform 120 allows companies to reach out to their users after a time delay (e.g., shopping cart abandonment). Mobile marketing platform 120 can determine the best time to reach out to the users so that one or more desired actions are taken (e.g., completing the purchase using the shopping cart). Mobile marketing platform 120 may have a range of times available with which to test for an optimal time. Mobile marketing platform 120 may run samples at various time intervals to determine the rate of desired behavior at the different times. Mobile marketing platform 120 may then direct more of the traffic toward the time or times that have the best outcomes.

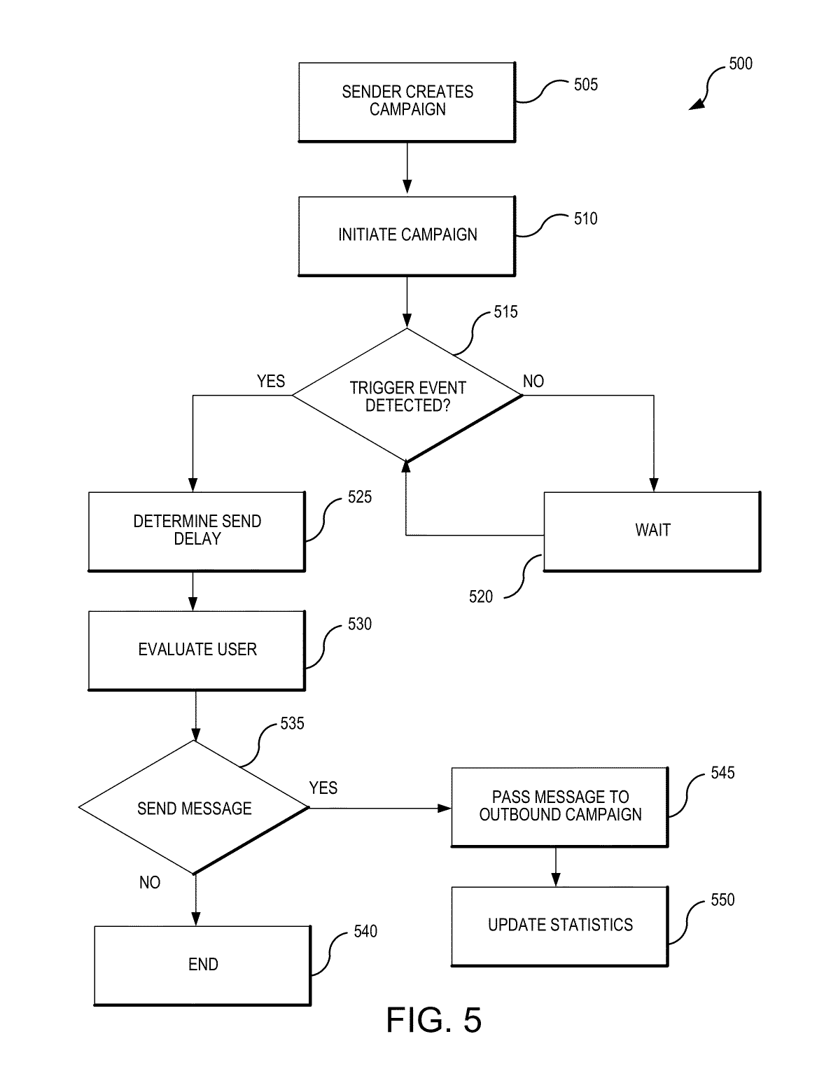

FIG. 5 is a flowchart illustrating an example of a set of operations that can be used in a sample campaign where a company wants to reach out to their users after a time delay. As illustrated in FIG. 5, during creation operation 505 a sender creates a campaign. In accordance with various embodiments, the sender can name the campaign, define a trigger event (e.g., “add to cart”), define a goal event (e.g., “complete checkout”), and/or optionally define additional filters (e.g., purchases <5). During creation operation 405 the sender may activate a time optimization feature and a desired time range (e.g., within 2 hours). The sender may also define a message or messages (e.g., say “1 push message”). Once completed, the sender can initiate (or launch) the campaign during initiation operation 510.

Determination operation 515 monitors various user activities and determines if a user performs the trigger event. If determination operation 515 determines that no triggers are found, then determination operation 515 branches to waiting operation 520. If determination operation 515 determines that a trigger has been detected for one or more users, the determination operation 515 branches to delay operation 525. In some embodiments, for each user that triggers the event, the system may check to see if he or she currently has a pending trigger. If the system finds a pending trigger, the system may cancel that trigger.

During delay operation 525, a send delay can be determined for each user. The send delay may be based on past performance (e.g., Thompson sampling from conjugate prior distributions). In some embodiments, the system may check to see if any additional filters are met. If these additional filters are not met, then the system may stop sending. In some embodiments, the system can schedule a trigger to be processed after the send delay has passed (e.g., puts an item on the queue for the campaign). Once the send delay passes, the user is loaded and evaluated during evaluation operation 530.

Determination operation 535 determines if the user has already completed the goal event. If so, then determination operation 535 determines that a message should not be sent and branches to termination operation 540. As part of evaluating whether a message should be sent, determination operation 535 may also check to see if any additional filters are still met. In addition, determination operation 535 may determine if rate limiting is in effect and if the user should be rate limited. If the user is rate limited, then determination operation 535 would branch to termination operation 540 and stop sending. Rate limiting reasons may include checking one or more of the following: 1) last time a message was sent to a user; 2) last time the user participated in this campaign; and/or 3) last time a message was sent to a device.

If determination operation 535 determines that a message should be sent, then determination operation 535 branches to passing operation 545 where the message is passed to the appropriate outbound campaign (e.g., queue the message for delivery via push notification, email, in-app message). The system may create a record or log of the send. The system may also update the user's profile to record the fact that a method of communication was sent to the user. In some embodiments, the system may use a transitory store, such as memcached, to not only store the fact that the user was sent a message but also to prevent storage eventual consistency from allowing a user to be double messaged. During recording operation 550, the statistics used to determine the success rate for the time the user was sent a message are updated (e.g., queue an increment for send count on the Campaign Aggregations queue). As time passes and the user completes the goal or becomes more engaged (as appropriate), recording operation 550 can update the statistics used to determine the success rate for the time the user was sent a message (e.g., queue an increment for success on the Campaign Aggregations queue).

The range of times for which testing occurs may be selected based on a sender preference to optimize over minutes, hours or days. The optimizer can select a set of times in the preferred range which represents the duration the system will delay before reaching out to the user with a campaign. For example, in the case of shopping cart abandonment, the system would initially randomly select wait times from the delay times initially set up.

To prevent sending a message to users who would normally complete a purchase without a message, the system may estimate the rate at which users are converting without a message by fitting parameters to a distribution, such as the Lomax random distribution, with the data collected during non-messaged conversions. The time delay that results in a desired amount of users (e.g., 98%) or maximum amount can be calculated using the Lomax distribution with estimated parameters and all send delay times before the determined targets (e.g., 98% percentile) are removed from consideration to avoid a premature messaging of the user.

The decision for which time delay to use when a message should be sent can be based on performing Thompson sampling from conjugate prior distributions representing the parameter estimates for the success rate of a specific send delay time. Each send delay time probability of success may be modeled as a distribution parameterized with the data collected for previous messages sent at the candidate time. The measures of success and failure are used to derive the parameters of the distribution. In some embodiments, the measuring of success and failure can be performed in real-time.

As data is collected over time, the parameter estimates for the prior distributions are updated, and the samples from the distributions for each send delay time reflect the adjustments in the distributions. Applying more data to the parameter estimates for each distribution causes the prior distributions to be more sharply defined around their mean and reduces the variance of the samples. The result is that the best success rate distributions become more prevalent in the Thompson sampling results, and the lower success rates asymptotically approach zero in their representation in the sample results.

Data collection for the send time delay statistics may be performed by recording event times for the trigger event, the message send event, and the success event on a per-user basis. When a user performs a trigger event, such as adding an item to a shopping cart, the event is recorded. When/if a message is sent, the time between the trigger and the message send is recorded, and when/if a success event is received for the corresponding trigger, the difference between the message send and trigger is recorded in a per-campaign “Sent-Success” histogram. In addition, a separate “Sent” histogram records the time between the trigger and message send whether a success is achieved or not. The success rate of a specific delay time is calculated by counting the number of message sends at or around the delay time recorded in the Sent-Success histogram divided by the number of message sends at or around the delay times recorded in the “Sent” histograms.

### Message Optimization

In a scenario where a company has decided to reach out to their users, it may be desirable to determine the best message to send to the users. The system may have a range of messages available with which to test for an optimal message. The system may run samples of various messages to determine the rate of desired behavior for the different messages. The system may then direct more and more of the traffic toward the message or messages that have the best outcomes. The success of a message is measured by a goal metric (e.g., did the user purchase) or an engagement metric (e.g., did the user respond to the message by clicking/viewing/other). The model parameter estimate for the likelihood of success (\hat{p}) for a specific message is achieved by using a Bayesian conjugate prior distribution. The likelihood of a message send in the future is determined by taking a sample from the posterior distribution composed of the prior distributions for each of the campaign messages.

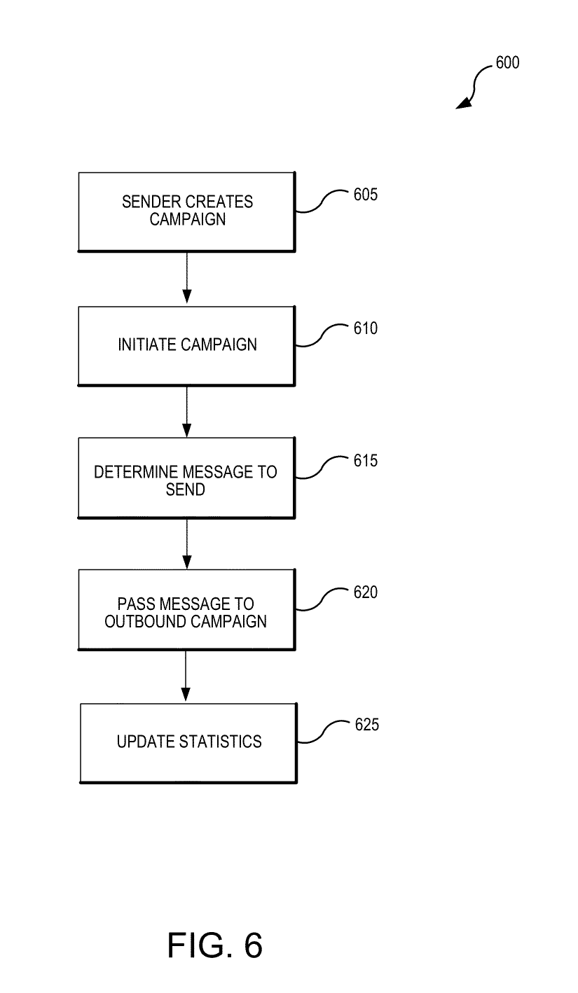

FIG. 6 is a flowchart illustrating an example of a set of operations that can be used in a message optimized campaign. As illustrated in FIG. 6, a sender creates a campaign during creation operation 605. In accordance with various embodiments, as a sender creates a campaign, the sender can name the campaign, specify when and how often the campaign will run (e.g., one time campaign as soon as possible), optionally define additional filters (e.g., purchases <5), turn on message optimization, and/or define multiple messages (e.g., two push messages). The campaign is then initiated or launched during initiation operation 610.

When the campaign fires (e.g., immediately for ASAP campaign, as scheduled for scheduled one-time campaigns, on trigger for conversion campaigns, daily for lifecycle campaigns), a user profile is loaded and the system may check to see if any additional filters are met. If additional filters are not met, the system will stop sending to that user. If rate limiting is in effect, a determination can be made as to whether the user should be rate limited. If the user is rate limited, the system will stop sending to that user. Rate limiting reasons may include checking one or more of the following: 1) last time a message was sent to a user; 2) last time the user participated in this campaign; and/or 3) last time a message was sent to a device.

During message determination operation 615, the system can determine the message to send based on past performance (e.g., Thompson sampling from conjugate prior distributions). The system may create a record or log of the send. The system may update the user to record the fact with a communication was sent to the user. In some embodiments, the system may use a transitory store, such as memcached, to also store the fact that the user was sent a message to prevent storage eventual consistency from allowing a user to be double messaged. During passing operation 620, the message can be passed to the appropriate outbound campaign (e.g., queue the message for delivery via push notification, email, or in-app message).

Recording operation 625 may update the statistics used to determine the success rate for the message the user was sent (e.g., update send count for a particular message). In some embodiments, as time passes, the system may determine that the user has completed the goal or becomes more engaged (as appropriate). Upon making such a determination, recording operation 625 may again update the statistics used to determine the success rate for the message the user was sent (e.g., update success count for a particular message). In some cases, a sender may change one or more messages. In some embodiments, recording operation 625 updates the statistics to change the send distribution to either: 1) reset it to neutral; 2) increase the send frequency; or 3) decrease the send frequency. In some embodiments, the distribution modification could be proportional to the extent of the change. In other cases, a sender may remove a message (e.g., by decreasing the message send frequency to zero). A sender may add a new message. The message should have some possibility to be sent to measure its success rate. That possibility may be proportional to its similarity to other messages in some embodiments. That possibility may start out temporarily pronounced to accelerate determining how this message compares to known messages (e.g., start out with 25% of all sends, get some results, and blend the traffic back to a normal distribution based on success rates).

The messages considered for sending to users are specified when the campaign is defined; specifically the customer decides the content of the message. Customers will typically experiment with different message text to identify word combinations that may be more effective in eliciting a response from the user.

When conditions in the system indicate a message is to be sent to a user, a decision for which message to send can be made. The message-to-send decision may be performed by Thompson sampling from distributions representing the success estimate conjugate prior for each message. Each message probability of success can be modeled as a distribution parameterized with the data collected for previous messages sent to the user. The measures of success and failure are used to derive the parameters of the distribution. The measuring of success and failure is performed in real-time.

As in the send time optimization, data collected over time from the results of the success and failures of previously sent messages can be used to update the parameter estimates for the prior distributions. The additional data serves to more sharply define the prior distributions and reduce the sample variance. The best success rate distributions become more prevalent in the Thompson sampling results and the lower success rate messages will asymptotically approach zero in their representation in the sample results.

Data collection for the campaign message success rate may be performed by counting the total number of times a campaign message is sent to users and counting the total number of times a campaign message send results in a success event. The success rate of a message may be calculated as the total success events divided by the total send events.

### Adaptive

When campaigns are running at scale, the response rates may change over time. The system may have a component that continues to sample different times or different messages to see if there is a shift in the rate of desired behavior, and it may adapt the campaigns to improve the rate of desired behavior. It may also be possible for a user of the system to add or remove from the list of available times for sending or modify the copy of a message or add or remove messages. In the case of a modification to send times or messaging, the system may adapt to determine how the changes affect the rate of desired behavior. The system may also allocate an additional portion of traffic to the new or modified values to more quickly determine how they compare to the existing or previous values.

To prevent the distributions used to estimate the success rate for each send delay time or campaign message from becoming unresponsive to change, the parameters can be limited from becoming too large. The updates of the parameters cap the maximum value of the sum of the parameters from exceeding a constant value specified by the system configuration.

### Responses and Tuning

The system may use a variety of response data to update parameters for a Bayesian network that models population parameters associated with the success estimate for the send time delay or the campaign message. The system may also incorporate other feedback, such as uninstall rates after receiving a push or push opt-out rates after receiving a push. As the population estimates become better defined, more confidence is gained in the estimates of the best selection of message and send delay time. The proportion of messages sent is adjusted to the combination of messages and send delay times which receives the best responses. When the estimate confidences reach a high threshold score, a “winner” may be picked for all future messages (pending potential changes). In addition to opt-out/uninstall/value of goal adjustments, the system may include some model of response rates as a function of the user's time-of-day or day-of-week.

### Targeted Push Times

Some embodiments of the system can target push times within a specified window such that the user is most likely to be available to interact with the device. The system may use prior daily and weekly events to form a prior use distribution (such as a Dirichlet distribution) as well as device recency to determine a best device and time for a push. In accordance with various embodiments, the system may select a push time for each individual user or a best time for a group or cluster of users. For example, for users without sufficient data, a population parameter may be used rather than a parameter derived from the user's data. Some embodiments may also classify clusters of users with similar time patterns and attempt early cluster assignment for users with small amounts of time patterns (using attributes of the user to identify the cluster). Statistics can be collected on each user as part of event processing and then later used during the campaign generation process.

All of the following steps can apply for a start date-time and following window for the send. For example, a customer running a campaign may select 2015-02-16 (Thursday) at 11:00 a.m. as the start time with an “Optimal-24” window. In this scenario, the system attempts to find the best time to message users on a Thursday using a 24-hour window starting at 11:00 a.m. Some embodiments allow for other standard windows (e.g., 4-hour window, 2-day window, 1-week window, etc.).

### Matching Day-of-Week Customer Events

Events received by a user and device matching the day-of-week and time window for the send are counted to determine the highest value activity times and count toward a score computed to determine the best send time. For example, a relatively large amount of customer-event activity at 12:00 p.m. would be a strong signal that 12:00 p.m. is a good (optimal) send time for that user and device. In addition, events which are the goals of the campaign (e.g., complete checkout) are counted with a higher weight (e.g., about five to ten times higher) than non-goals of the campaign to increase likelihood of choosing a time correlated with the campaign goal is higher.

### Daily Pattern

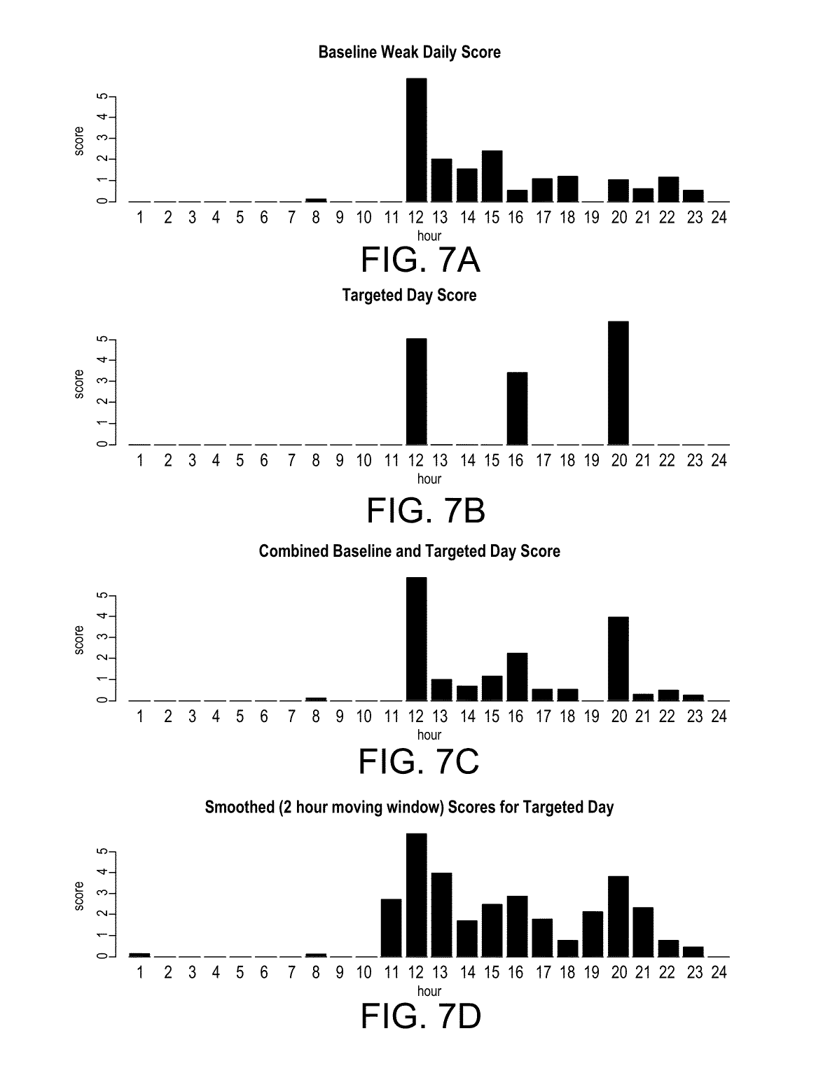

All day-of-week customer events are aggregated to form a single-day pattern of customer behavior which will be used to predict user behavior if there are no events within the requested send window. FIGS. 7A-7D illustrate several examples of histograms of the collected and processed customer behavior according to various embodiments of the present technology. FIG. 7A illustrates a histogram labeled “Baseline Week Daily Score.” The scores shown in FIG. 7A are from every day of the week and are combined to build a single day score profile (e.g., weighted 1/7-1/10). The “Targeted Day Score” graph illustrated in FIG. 7B show the scores for events falling directly on the day targeted for the delivery interval. The combined score shown in FIG. 7C is the sum of the first two graphs, and finally the “Smoothed” (2-hour moving window). Scores for the “Targeted Day” graph illustrated in FIG. 7D represent the scores after the 2-hour moving average window is applied to the combined scores. The scores for each graph illustrated are computed by a sum of the weighed by 1/20 maintenance events, weighed by 1/1 the customer non-goal events, and the weighed 5/1 goal events. Other embodiments may use different weightings, scores, and/or events.

The daily pattern can then be formed from low-value system activity events (derated as discussed) and high-value customer events. The combined daily pattern may be treated as a lower-value predictor (e.g., weighted ˜1/7-1/20) compared to matching day-of-week customer events in some embodiments.

Consider the following illustrative example. Assume the specified target delivery interval for a campaign is day-1 24 hours starting at midnight. In this case, the optimal send-time will be computed as the sum of the baseline every day-hour score+the target day-1-hour score with a 2-hour moving average smoothing applied. The score for the baseline and the target day are computed as the weighted sum of (count of events for each hour of type “kahuna”*0.1)+(count of non-goal customer events for each hour)+(count of goal customer events*5.0). If, in this case, the hour-1 baseline had 5 system events, 3 non-goal customer events and 1 goal event, the baseline score would be (5*0.05+3+5)*0.10=0.825. If the target day-hour-1 had 1 system event, 1 non-goal customer event and 1 goal event, the target day score would be (1*0.05+1+5)=6.05. The combined score would be 6.88 for the day-1 hour-1, before the smoothing operation. The smoothing operation depends on adjacent time points, so if the before and after scores were 0, the smoothed value would be (0*0.5+6.88+0*0.5)/2=3.44.

### System Events

System-specific events can be generated and tracked by some embodiments of the system. System-specific events are generally not business goals or objectives of the campaign but provide some information about the user's activity (e.g., logging into an application). The following are some events sent by the implementation for the purpose of operation: “start application,” “user clicked on push message,” “user logged in,” “user logged out,” “user disabled push,” “user enabled push,” “user attribute was set by application,” “user location in defined region.” These events are somewhat meaningful in tracking user behavior, but customer events are more meaningful. As a result, these events can be weighted (e.g., ˜1/20-1/50) of the value of a customer event. These events can provide a meaningful prior distribution of activity in the absence of more meaningful customer events. The low-value prior is formed for a daily and weekly pattern as a means for prediction of user behavior.

### Smoothing, Center of Mass

The combined score of Day-Of-Week Customer Events, Daily Pattern and System Events form a profile for the best times in the send window. To make the scores more robust to outliers, the scores can be smoothed using a 2-hour moving average (e.g., 0.5 hours behind, 0.5 hours ahead) to prefer larger regions of higher activity over a narrower/single time points of activity.

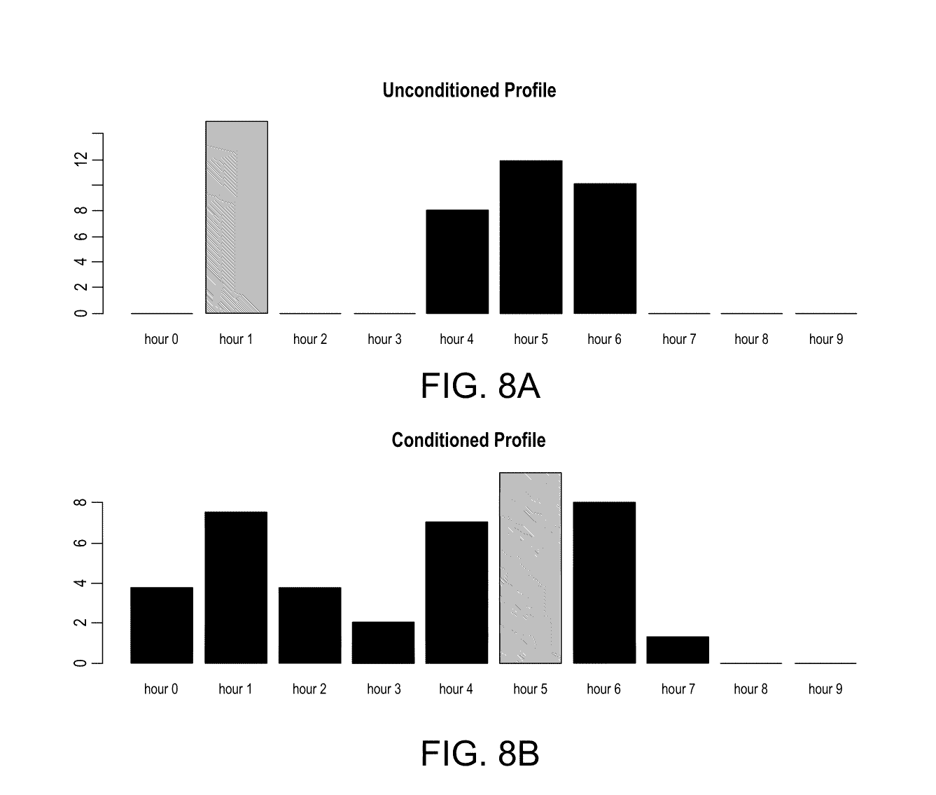

FIGS. 8A-8B illustrate plots of unconditioned profile data and conditioned profile data, respectively, that may be used in one or more embodiments of the present technology. On the plot, the unconditioned data indicates hour 1 as the best scoring time. This time has drawbacks, however, because the data is surrounded by times without any activity or indication of activity. On the conditioned data plot (which is the result of smoothing), hour 5 is indicated as the highest scoring send time because the smoothing function takes into account surrounding activity hours. The smoothing operation identifies periods of time which are generally more likely to be good send times rather than a narrow point time which may be difficult to target or may not elicit the user's interaction due to restrictions in the time window. The following equation describes an example of smoothing (where c is the conditioned time score and u is the unconditioned time score and t is the time point):

c(t)=0.25·u(t−1)+0.5·u(t)+0.25·u(t+1)

### Device Recency

Last-event dates for devices are indicators of device usage. Scores computed for optimal send-time decay super-exponentially according to the number of weeks since the last event of the device relative to the latest event received from the user. The score modifier is calculated 2̂−(2̂numWeeksSinceLastEvent−0.5). The numWeeksSinceLastEvent can be rounded down. In accordance with some embodiments, the values from this modifier are (0, 1, 2, 4, 5 weeks): 1.000, 0.707, 0.3536, 0.0883, 0.0055. After 1 week device non-use relative to the latest event received, the device modifier is 0.707 of the most recent device. After 2 weeks of non-use, it is 0.3536 of the latest device, etc. Note that a user which stops using all their devices for one week will not have a score adjustment since the adjustment is only made relative to the latest event received from the user.

### Send Time Decision

The optimal send time decision can be performed using the <device-day-time> score profile computed as described above. In some embodiments, the system can take the highest score in the profile for the given window, finds all scores within 95% of the value of the highest score and finds the earliest time from those scores. This becomes the optimal send-time.

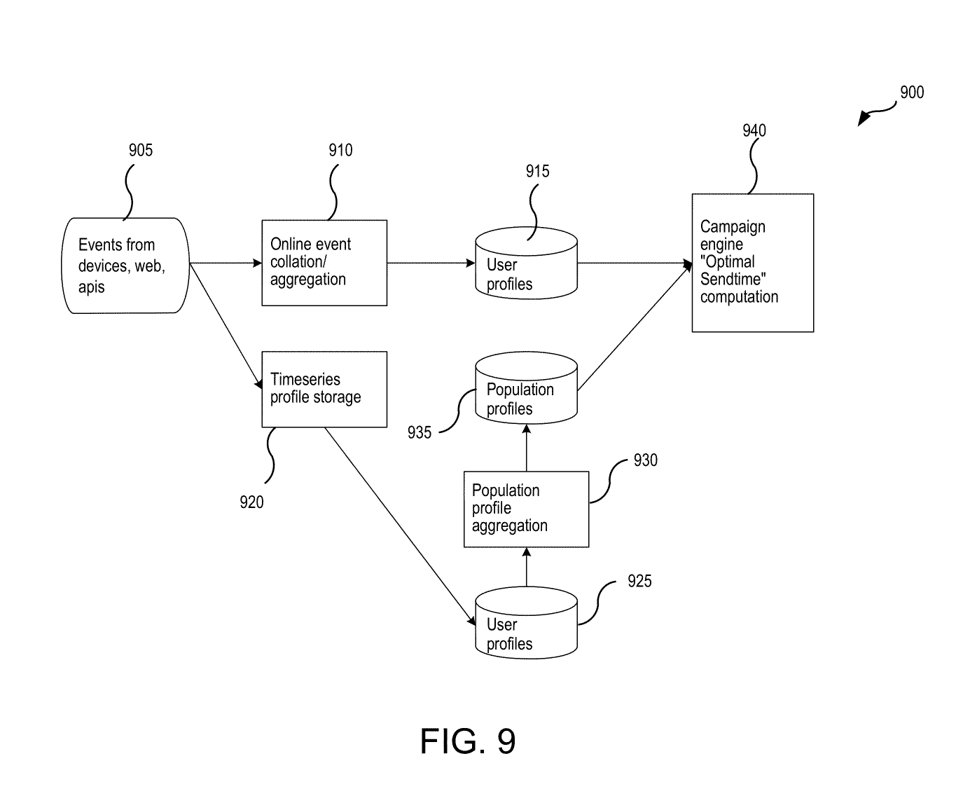

FIG. 9 is a block diagram illustrating an example of a processing flow for computing an optimal send time. As illustrated in FIG. 9, the events from various devices, the web, or APIs are collected during collection operation 905. These events are passed to an online event collation and aggregation module 910 which updates individual user profiles 915. In addition, the collected event data is stored by time series profile storage module 920. This information is used to update user profiles 925, which are then aggregated by population profile aggregator 930 to generate population profiles 935. The population profiles 935 and individual user profiles 915 are used by the campaign engine 940 to compute an optimal send time for campaign messages.

### Other Considerations

The time resolution of the algorithm may vary from one hour or more to less than fifteen minutes. For users with no events, the statistics from the entire population can be used to provide information for the user. Additional information based on user habits (rather than population statistics) may be used to cluster user groups and provide more meaningful group statistics for time period with little or no user interaction (than population statistics). The weighting parameters in this model can be obtained by fitting the model to user data to maximize the likelihood of reaching a goal.

### Exemplary Computer System Overview

Aspects and implementations of the marketing system of the disclosure have been described in the general context of various steps and operations. A variety of these steps and operations may be performed by hardware components or may be embodied in computer-executable instructions, which may be used to cause a general-purpose or special-purpose processor (e.g., in a computer, server, or other computing device) programmed with the instructions to perform the steps or operations. For example, the steps or operations may be performed by a combination of hardware, software, and/or firmware.

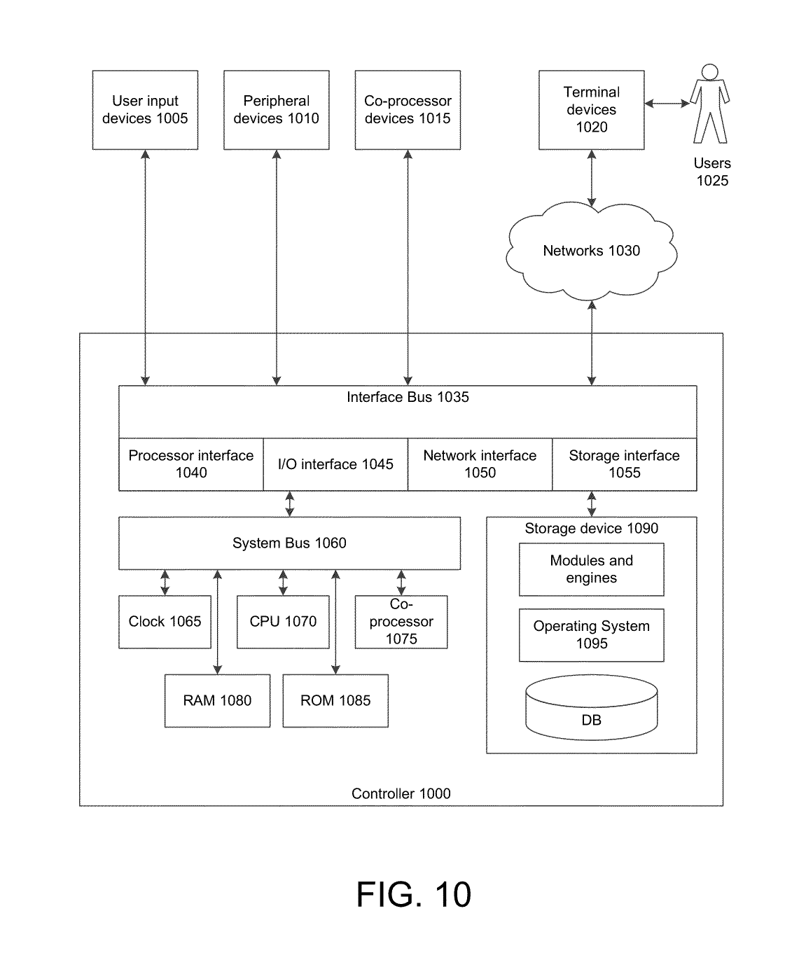

FIG. 10 is a block diagram illustrating an example machine representing the computer systemization of the marketing system. The marketing system controller 1000 may be in communication with entities, including one or more users 1025, client/terminal devices 1020, user input devices 1005, peripheral devices 1010, an optional co-processor device(s) (e.g., cryptographic processor devices) 1015, and networks 1030. Users may engage with the controller 1000 via terminal devices 1020 over networks 1030.

Computers may employ central processing units (CPU) or processors (hereinafter “processor”) to process information. Processors may include programmable general-purpose or special-purpose microprocessors, programmable controllers, application-specific integrated circuits (ASICs), programmable logic devices (PLDs), embedded components, or a combination of such devices and the like. Processors execute program components in response to user and/or system-generated requests. One or more of these components may be implemented in software, hardware, or both hardware and software. Processors pass instructions (e.g., operational and data instructions) to enable various operations.

The controller 1000 may include clock 1065, CPU 1070, memory such as read-only memory (ROM) 1085 and random access memory (RAM) 1080, and co-processor 1075, among others. These controller components may be connected to a system bus 1060, and through the system bus 1060, to an interface bus 1035. Further, user input devices 1005, peripheral devices 1010, co-processor devices 1015, and the like, may be connected through the interface bus 1035 to the system bus 1060. The interface bus 1035 may be connected to a number of interface adapters such as processor interface 1040, input/output interfaces (I/O) 1045, network interfaces 1050, storage interfaces 1055, and the like.

Processor interface 1040 may facilitate communication between co-processor devices 1015 and co-processor 1075. In one implementation, processor interface 1040 may expedite encryption and decryption of requests or data. Input/output interfaces (I/O) 1045 facilitate communication between user input devices 1005, peripheral devices 1010, co-processor devices 1015, and/or the like and components of the controller 1000 using protocols such as those for handling audio, data, video interface, wireless transceivers, or the like (e.g., Bluetooth, IEEE 10394a-b, serial, universal serial bus (USB), Digital Visual Interface (DVI), 802.11a/b/g/n/x, cellular, etc.). Network interfaces 1050 may be in communication with the network 1030. Through the network 1030, the controller 1000 may be accessible to remote terminal devices 1020 (e.g., client devices, laptops, computers, mobile devices, smart phones, tablets, etc.). Network interfaces 1050 may use various wired and wireless connection protocols such as, direct connect, Ethernet, wireless connection such as IEEE 802.11a-x, and the like.

Examples of network 1030 include the Internet, Local Area Network (LAN), Metropolitan Area Network (MAN), a Wide Area Network (WAN), wireless network (e.g., using Wireless Application Protocol WAP), a secured custom connection, and the like. The network interfaces 1050 can include a firewall which can, in some embodiments, govern and/or manage permission to access/proxy data in a computer network and track varying levels of trust between different machines and/or applications. The firewall can be any number of modules having any combination of hardware and/or software components able to enforce a predetermined set of access rights between a particular set of machines and applications, machines and machines, and/or applications and applications, for example, to regulate the flow of traffic and resource sharing between these varying entities. The firewall may additionally manage and/or have access to an access control list which details permissions including, for example, the access and operation rights of an object by an individual, a machine, and/or an application, and the circumstances under which the permission rights stand. Other network security functions performed or included in the functions of the firewall, can be, for example, but are not limited to, intrusion prevention, intrusion detection, next-generation firewall, personal firewall, etc., without deviating from the novel art of this disclosure.

Storage interfaces 1055 may be in communication with a number of storage devices such as storage devices 1090, removable disc devices, and the like. The storage interfaces 1055 may use various connection protocols such as Serial Advanced Technology Attachment (SATA), IEEE 1394, Ethernet, Universal Serial Bus (USB), and the like.

User input devices 1005 and peripheral devices 1010 may be connected to I/O interface 1045 and potentially other interfaces, buses and/or components. User input devices 1005 may include card readers, fingerprint readers, joysticks, keyboards, microphones, mouses, remote controls, retina readers, touch screens, sensors, and/or the like. Peripheral devices 1010 may include antennas, audio devices (e.g., microphones, speakers, etc.), cameras, external processors, communication devices, radio frequency identifiers (RFIDs), scanners, printers, storage devices, transceivers, and/or the like. Co-processor devices 1015 may be connected to the controller 1000 through interface bus 1035, and may include microcontrollers, processors, interfaces or other devices.

Computer executable instructions and data may be stored in memory (e.g., registers, cache memory, random access memory, flash, etc.), which is accessible by processors. These stored instruction codes (e.g., programs) may engage the processor components, motherboard and/or other system components to perform desired operations. The controller 1000 may employ various forms of memory including on-chip CPU memory (e.g., registers), RAM 1080, ROM 1085, and storage devices 1090. Storage devices 1090 may employ any number of tangible, non-transitory storage devices or systems such as a fixed or removable magnetic disk drive, an optical drive, solid state memory devices, and other processor-readable storage media. Computer-executable instructions stored in the memory may include the marketing systems having one or more program modules such as routines, programs, objects, components, data structures, and so on that perform particular tasks or implement particular abstract data types. For example, the memory may contain operating system (OS) component 1095, modules, engines, other components, database tables, and the like. These modules/components may be stored and accessed from the storage devices, including from external storage devices accessible through an interface bus.

The database components can store programs executed by the processor to process the stored data. The database components may be implemented in the form of a database that is relational, scalable and secure. Examples of such databases include DB2, MySQL, Oracle, Sybase, and the like. Alternatively, the database may be implemented using various standard data-structures, such as an array, hash, list, struct, structured text file (e.g., XML), table, and/or the like. Such data-structures may be stored in memory and/or in structured files.

The controller 1000 may be implemented in distributed computing environments, where tasks or modules are performed by remote processing devices, which are linked through a communications network, such as a Local Area Network (“LAN”), Wide Area Network (“WAN”), the Internet, and the like. In a distributed computing environment, program modules or subroutines may be located in both local and remote memory storage devices. Distributed computing may be employed to load balance and/or aggregate resources for processing. Alternatively, aspects of the controller 1000 may be distributed electronically over the Internet or over other networks (including wireless networks). Those skilled in the relevant art will recognize that portions of the marketing system may reside on a server computer, while corresponding portions reside on a client computer. Data structures and transmission of data particular to aspects of the controller 1000 are also encompassed within the scope of the technology.

### CONCLUSION

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof means any connection or coupling, either direct or indirect, between two or more elements; the coupling or connection between the elements can be physical, logical, or a combination thereof. Additionally, the words “herein,” “above,” “below,” and words of similar import, when used in this application, refer to this application as a whole and not to any particular portions of this application. Where the context permits, words in the above Detailed Description using the singular or plural number may also include the plural or singular number respectively. The word “or,” in reference to a list of two or more items, covers all of the following interpretations of the word: any of the items in the list, all of the items in the list, and any combination of the items in the list.

The above Detailed Description of examples of the technology is not intended to be exhaustive or to limit the technology to the precise form disclosed above. While specific examples for the technology are described above for illustrative purposes, various equivalent modifications are possible within the scope of the technology, as those skilled in the relevant art will recognize. For example, while processes or blocks are presented in a given order, alternative implementations may perform routines having steps, or employ systems having blocks, in a different order, and some processes or blocks may be deleted, moved, added, subdivided, combined, and/or modified to provide alternative or subcombinations. Each of these processes or blocks may be implemented in a variety of different ways. Also, while processes or blocks are at times shown as being performed in series, these processes or blocks may instead be performed or implemented in parallel, or may be performed at different times. Further, any specific numbers noted herein are only examples: alternative implementations may employ differing values or ranges.

The teachings of the technology provided herein can be applied to other systems, not necessarily the system described above. The elements and acts of the various examples described above can be combined to provide further implementations of the technology. Some alternative implementations of the technology may include not only additional elements to those implementations noted above, but also may include fewer elements.

These and other changes can be made to the technology in light of the above Detailed Description. While the above description describes certain examples of the technology, and describes the best mode contemplated, no matter how detailed the above appears in text, the technology can be practiced in many ways. Details of the system may vary considerably in its specific implementation, while still being encompassed by the technology disclosed herein. As noted above, particular terminology used when describing certain features or aspects of the technology should not be taken to imply that the terminology is being redefined herein to be restricted to any specific characteristics, features, or aspects of the technology with which that terminology is associated. In general, the terms used in the following claims should not be construed to limit the technology to the specific examples disclosed in the specification, unless the above Detailed Description section explicitly defines such terms. Accordingly, the actual scope of the technology encompasses not only the disclosed examples, but also all equivalent ways of practicing or implementing the technology under the claims.

To reduce the number of claims, certain aspects of the technology are presented below in certain claim forms, but the applicant contemplates the various aspects of the technology in any number of claim forms. For example, while only one aspect of the technology is recited as a computer-readable medium claim, other aspects may likewise be embodied as a computer-readable medium claim, or in other forms, such as being embodied in a means-plus-function claim. Any claims intended to be treated under 35 U.S.C. §112(f) will begin with the words “means for”, but use of the term “for” in any other context is not intended to invoke treatment under 35 U.S.C. §112(f). Accordingly, the applicant reserves the right to pursue additional claims after filing this application to pursue such additional claim forms, in either this application or in a continuing application.

What is claimed is:

1. A computer-implemented method for operating a mobile marketing platform, the method comprising:
receiving, at the mobile marketing platform via a communications network from one or more mobile devices, indications of user activity with the one or more mobile devices and event activity;
creating customized user profiles from the indications of user activity with the one or more mobile devices and the event activity,
wherein the customized user profiles include time profiles of usage of the one or more mobile devices;
receiving, at the mobile marketing platform, a request to initiate a marketing campaign,
wherein the request to initiate the marketing campaign includes an initial timeframe and frequency of the marketing campaign, and
automatically launching, from the mobile marketing platform, the marketing campaign,
wherein the mobile marketing platform access the customized user profiles and individually selects a message to send, a send time for the message, and a target device for each user in a subset of users based on the customized user profiles.

2. The computer-implemented method of claim 1, wherein the request to initiate the campaign includes one or more filters and the method further comprises:
determining, after the launch of the campaign if the customized user profiles of each of the subset of users meets the one or more filters;
cancelling the message to any of the subset of users that have customized user profiles that do not meet the one or more filters; and
sending the message at the send time to any of the subset of users that have customized profiles that meet the one or more filters.

3. The computer-implemented method of claim 1, further comprising updating the customized user profiles to indicate when the message was sent to one of the subset of users.

4. The computer-implemented method of claim 3, further comprising:
determining, after launching the campaign, if rate limiting should be applied to any of the subset of users; and
cancelling the message to any of the subset of users that should be rate limited based on the customized user profiles.

5. The computer-implemented method of claim 1, wherein the request to initiate the marketing campaign includes a starting trigger and the marketing campaign is automatically launched upon detection of the starting trigger.

6. The computer-implemented method of claim 1, wherein time profiles of usage of the one or more mobile devices includes smoothed hourly scores generated using a moving window.

7. The computer-implemented method of claim 1, further comprising creating an aggregated group profile from the indications of user activity with the one or more mobile devices and the event activity.

8. The computer-implemented method of claim 1, further comprising monitoring for responses to the message sent to each user and generating analytics based on the responses.

9. A marketing platform comprising:
a memory;
a processor;
a communications module to event data regarding usage of one or more mobile devices;
an event aggregation module, under control of the processor, configured to—
aggregate the event data received via the communications module; and
generate one or more user profiles based on the event data;
a campaign engine, under control of the processor, configured to—
launch a campaign that automatically tunes the content and send time based on the one or more user profiles;
evaluate each of the one or more user profiles and determine an optimal send delay for each user based on the one or more user profiles;
determine if a message should be sent to each of the one or more users; and
pass each message to a distribution engine that should be sent to each of the one or more users,
wherein the distribution engine transmits the message upon passage of the optimal send delay for each user.

10. The marketing platform of claim 9, further comprising:
an evaluation engine to monitor the results each message sent by the distribution engine; and
wherein the campaign engine automatically adjusts the campaign based on the results.).

11. The marketing platform of claim 9, wherein the distribution engine include third-party push service or a third party email server.

12. The marketing platform of claim 9, wherein the campaign engine is further configured to:
determine for each user if there are any pending in-app messages; and
cancel any current messages for each user scheduled to be sent before passing them to the distribution engine when there is a pending in-app message.

13. The marketing platform of claim 9, wherein the campaign engine is further configured to:
determine, after the launch of the campaign if the one or more user profiles of each of the one or more users meets one or more filters; and
cancel the message to any of the one or more users that have user profiles that do not meet the one or more filters.

14. The marketing platform of claim 9, further comprising device tracking engine to track the usage of the one or more mobile devices.

15. The marketing platform of claim 9, wherein the campaign engine is further configured to use the one or more user profiles to identify an optimal send for each user that increases the likelihood of one or more goals being met.

16. A computer-readable medium, excluding transitory signals, storing instructions that when executed by one or more processors cause a machine to:
receive indications of event activity and user interactions with one or more mobile devices;
creating customized user profiles from the indications of event activity and user interactions with the one or more mobile devices,
wherein the customized user profiles include time profiles of historical usage of the one or more mobile devices; and
wherein the customized user profiles include mobile device profiles of historical device usage;
receive a request to initiate a marketing campaign,
wherein the request to initiate the marketing campaign includes an initial timeframe and frequency of the marketing campaign, and
automatically launch the marketing campaign,
wherein the customized user profiles are used to individually selects a message to send, a send time for the message, and a target device for each user in a subset of users based on the customized user profiles.

17. The computer-readable medium of claim 16, storing instructions that when executed by one or more processors additionally cause the machine to:
determine, after the launch of the campaign if the customized user profiles of each of the subset of users meets the one or more filters;
cancel the message to any of the subset of users that have customized user profiles that do not meet the one or more filters; and
send the message at the send time to any of the subset of users that have customized profiles that meet the one or more filters.

18. The computer-readable medium of claim 16, storing instructions that when executed by one or more processors additionally cause the machine to:
update the customized user profiles to indicate when the message was sent to one of the subset of users.
determine, after launching the campaign, if rate limiting should be applied to any of the subset of users; and
cancel the message to any of the subset of users that should be rate limited based on the customized user profiles.

19. The computer-readable medium of claim 16, wherein the time profiles of usage of the one or more mobile devices includes smoothed hourly scores generated using a moving window.

20. The computer-readable medium of claim 16, storing instructions that when executed by one or more processors additionally cause the machine to create an aggregated group profile from the indications of user activity with the one or more mobile devices and the event activity
